(19) United States
(12) Patent Application Publication
(10) Pub. No.: US 2009/0268230 A1
(43) Pub. Date: Oct. 29, 2009

(54) COMPENSATION SYSTEM FOR PRODUCTION PRINTING ENVIRONMENT

(75) Inventor: Sudhendu Rai, Fairport, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 12/109,390

(22) Filed: Apr. 25, 2008

(51) Int. Cl. G06F 3/12

(52) U.S. Cl. 358/1.15

(57) ABSTRACT

A system is provided for planning compensation for a document processing arrangement including a plurality of document processing related cells with each document processing related cell including a plurality of document processing related devices functioning cooperatively to create a cell throughput. In practice, a processor may be instructed to read both a stored functional description of each device in at least one of the plurality of document processing related cells and a set of job processing related information. Responsive to such reading, the processor performs a simulation with the simulation being used to generate a simulated throughput value representative of a predicted output of the at least one of the plurality of document processing related cells within a time interval. In turn, compensation for an operator responsible for operating the at least one of the plurality of document processing related cells is varied on the basis of the simulated throughput representative of the predicted output of the at least one of the plurality of document processing related cells within the time interval.

### BACKGROUND AND SUMMARY

The disclosed embodiments relate generally to a compensation scheme for a production printing environment and, more particularly, to an incentive based system suited for use with a centralized or distributed print “shop” having one or more document processing cells.

Referring to FIGS. 1A and 1B, a conventional print shop organized into functional departments is shown. In these types of conventional print shops, operators are skilled in providing specific functions. For instance, in one part of a given shop, an operator may be particularly trained for operating printers; in another part of the shop, an operator may be particularly trained for handling insertions; and so on. In this sort of print shop, the throughput of each device is well known and the variation in device specifications is well understood. In one example, it may be known that a given printing device (“printer x”) has an output rate of 6000 pages/hour for 8.5×11 sheets and a lower output rate for 11×17 sheets. For this type of shop, it is easy to establish, given the workload how much time it will take to print the work. That is, the throughput of a print department with printer x can be established at 48000 prints for an 8 hour shift. It is often desirable for a print shop to compensate employees on the basis of targets set in view of output rates. Accordingly, a print shop manager may set a target for an operator running a specific device based on its expected speed and provide additional pay incentives for meeting and/or exceeding this target.

As taught by U.S. Pat. No. 7,079,266 to Ral et al., a print shop may be reorganized into autonomous cells. For each autonomous cell in a corresponding group, resources (e.g., equipment) are grouped together according to different job classes commonly encountered by a specific print shop. The jobs may then be broken down into smaller subjobs and processed through the cells. Another approach for improving print shop operation includes cross-training operators on multiple pieces of equipment. Operators can then be allocated more flexibly as needed throughout the shop. For one example of operation, in a print shop of the type contemplated by the '266 patent, a given cell would contain a mix of resources (possibly including printers and inserters), and operators would be cross-trained to operate the resources. Jobs to be processed in the given cell would vary in terms of requirements (such as number of pages to be printed and number of pages to be inserted). Depending on requirement, a bottleneck could occur at the printer or inserter. If the bottleneck is at the printer, then idling might occur at the inserter and vice-versa. Thus the throughput of the cell may be dictated by the job mix introduced to the cell (as opposed to the willingness of any given operator to work faster or harder). In a cell-based print production environment, undesirable results (for some or all print shop personnel) can occur when a print shop manager uses a compensation scheme based on conventionally structured print shop operation (with departments devoted to single functions) rather than a print shop with cellular layout.

In one aspect of the disclosed embodiments there is disclosed a system for planning compensation for a document processing arrangement including a plurality of document processing related cells. Each document processing related cell includes a plurality of document processing related devices functioning cooperatively to create a cell throughput. The system includes: A. a processor; B. a memory for storing (a) a functional description of each document processing related device in at least one of the plurality of document processing related cells in memory, and (b) a set of job processing related information in memory, the set of job processing related information corresponding with a number of jobs to be processed with the at least one of the plurality of document processing related cells, said memory comprising one or more programming instructions that, when executed, instruct the processor to: (1) read both the stored functional description of each device in the at least one of the plurality of document processing related cells and the set of job processing related information, (2) responsive to said B(1), perform a simulation with the simulation being used to generate a simulated throughput value representative of a predicted output of the at least one of the plurality of document processing related cells within a time interval, and (3) vary compensation for an operator responsible for operating the at least one of the plurality of document processing related cells based on the simulated throughput representative of the predicted output of the at least one of the plurality of document processing related cells within the time interval.

In accordance with another aspect of the disclosed embodiments there is disclosed a system for planning compensation for a document processing arrangement including a plurality of document processing related cells. Each document processing related cell includes a plurality of document processing related devices functioning cooperatively to generate a cell output. The system includes: A. a processor; B. a memory for storing (a) a functional description of each document processing device in at least one of the document processing related cells, the at least one of the plurality of document processing related cells including a first document processing related device operated by a first operator and a second document processing related device operated by a second operator, and (b) a set of job processing related information, the set of job processing related information corresponding with a number of jobs to be processed with the at least one of the plurality of document processing related cells, said memory comprising one or more programming instructions that, when executed, instruct the processor to: (1) read both the stored functional description of each document processing related device in the at least one of the document processing related cells and the set of job processing related Information, (2) responsive to said B(2), use the processor to perform a simulation with the simulation being used to generate a first simulated throughput value representative of a predicted output of the first document processing related device within a first time interval and a second simulated throughput value representative of a predicted output for the second document processing related device within a second time interval; and (3) compensate the first and second operators based on the first and second simulated throughput values.

In yet another aspect of the disclosed embodiments there is disclosed a method for planning compensation for a document processing arrangement including a plurality of document processing related cells. Each document processing related cell includes a plurality of document processing related devices functioning cooperatively to create a cell throughput. The method includes: A. storing a functional description of each document processing related device in at least one of the plurality of document processing related cells in memory; B. storing a set of job processing related information in memory, the set of job processing related information corresponding with a number of jobs to be processed with the at least one of the plurality of document processing related cells; C. reading, with a processor, both the stored functional description of each device in the at least one of the plurality of document processing related cells and the set of job processing related information; D. responsive to said C., using the processor to perform a simulation with the simulation being used to generate a simulated throughput value representative of a predicted output from the at least one of the plurality of document processing related cells within a time interval; and E. varying compensation for an operator of the at least one of the plurality of document processing related cells based on the simulated throughput representative of the predicted output from the at least one of the plurality of document processing related cells within the time interval.

In accordance with another aspect of the disclosed embodiments there is disclosed a method for planning compensation for a document processing arrangement including a plurality of document processing related cells. Each document processing related cell includes a plurality of document processing related devices functioning cooperatively to generate a cell output. The method includes: A. storing, in memory, a functional description of each document processing device in at least one of the document processing related cells, the at least one of the plurality of document processing related cells including a first document processing related device operated by a first operator and a second document processing related device operated by a second operator; B. storing a set of job processing related information in memory, the set of job processing related information corresponding with a number of jobs to be processed with the at least one of the plurality of document processing related cells; C. reading, with a processor, both the stored functional description of each document processing related device in the at least one of the document processing related cells and the set of job processing related information; D. responsive to said C., using the processor to perform a simulation with the simulation being used to generate a first simulated throughput value representative of a predicted output of the first document processing related device within a first time interval and a second simulated throughput value representative of a predicted output for the second document processing related device within a second time interval; and E. compensating the first and second operators based on the first and second simulated throughput values.

### BRIEF DESCRIPTION OF THE DRAWINGS

FIGS. 1A and 1B collectively represent a plan, block diagrammatic view of a conventional print shop organized into functional departments;

FIG. 2 is a block diagram of a compensation planning system developed in accordance with the disclosed embodiments;

FIG. 3 is a plan, block diagrammatic view of a cell based print shop suitable for use with the compensation planning system of the disclosed embodiments;

FIG. 4 is a plan view of a user interface screen suitable for designating, among other things, equipment characteristics, elements of an associated cell, scheduling policies, number of operators and their skill level; and

FIG. 5 is a flow diagram corresponding with a workflow for, among other things, determining throughput targets to compensate cell/device operators.

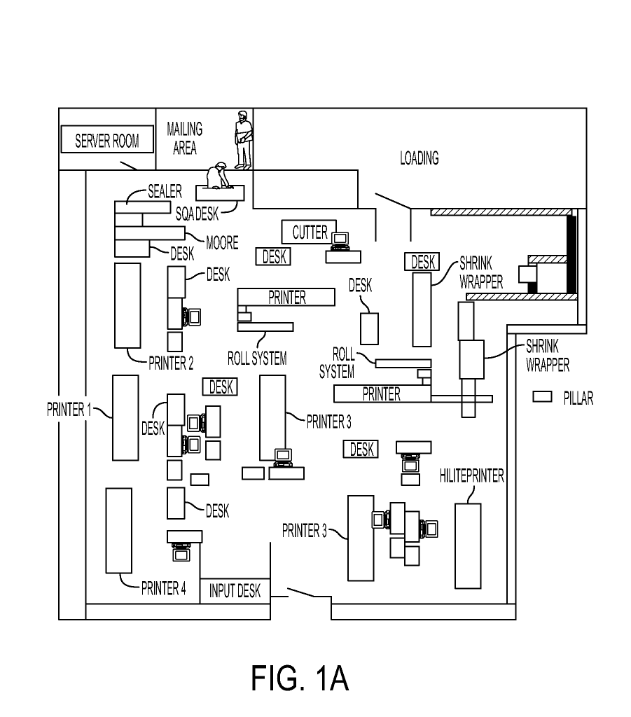

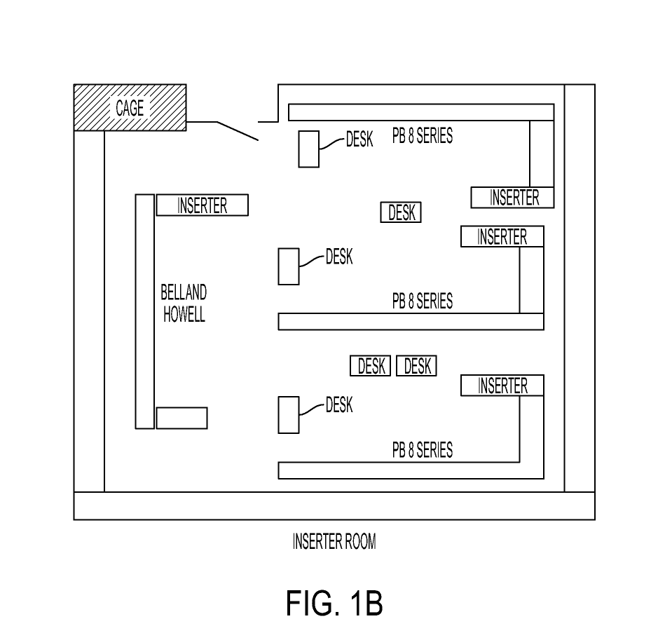

### DESCRIPTION OF DISCLOSED EMBODIMENTS

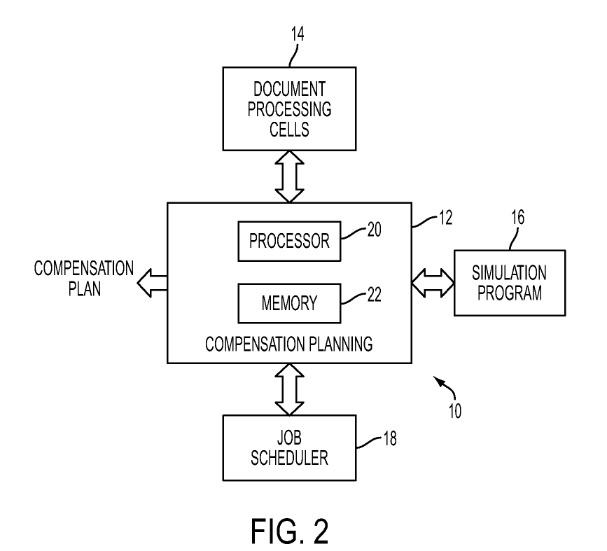

Referring now to FIG. 2, a compensation planning system, developed in accordance with the disclosed embodiments, is designated by the numeral 10. In practice, a compensation planning processing center 12 communicates with three modules, namely one or more document processing cells 14, a simulation program 16 and a job scheduler 18. The processing center 12, which may be implemented by reference to U.S. Pat. No. 7,065,567 to Squires et al., the pertinent portions of which are incorporated herein by reference, includes a suitable processor 20 and memory 22.

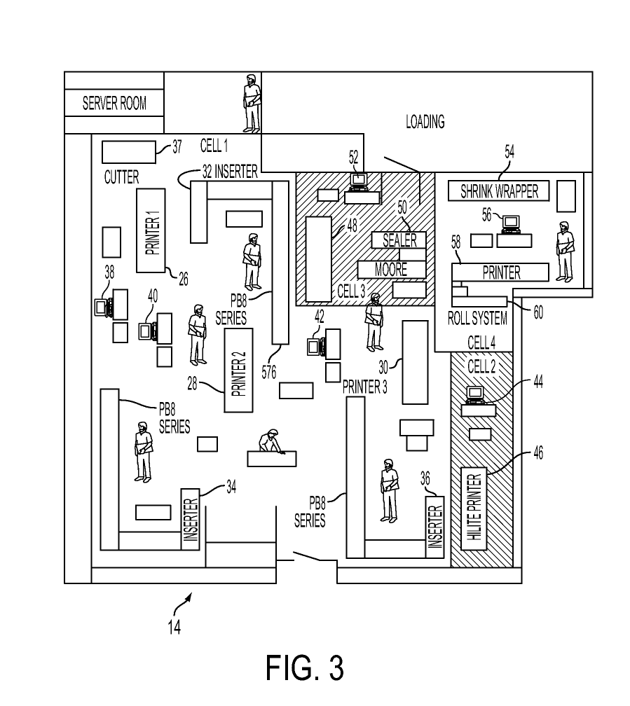

A first one of the inputs for the processing center 12, namely document processing cells 14, may be implemented in accordance with the disclosure of U.S. Pat. No. 7,079,266 to Rai et al., the pertinent portions of which are incorporated herein by reference. More particularly, referring to FIG. 3, Cell 1 includes printers 26, 28, 30 and inserters 32, 34, 36. A cutter 37 is also included in cell 1 as are computing resources 38, 40, 42. The resources may include server computers that execute software for automatically assigning print jobs to given cells and for processing print jobs once they arrived in the given cells. Moreover, the computing resources may provide the print shop operators to control the operation of the equipment within the cell. Cell 2 includes computer system 44 and a highlight printer 46. Cell 3 includes a printer 48 as well as a sealer 50 and a computer system 52. Lastly, cell 4 includes a shrink wrapper 54, computer system 56, a printer 58 and a roll system 60. The relevant data defining the processing of a job through a print shop is acquired in a manner in accordance with the present embodiments to facilitate print shop rearrangement or job processing adjustments between the cells and the elements in the cell. Also, the processing center 12 may be implemented with one or more of the computer systems of cells 14.

The arrangement of FIG. 3 is exemplary and, as will be appreciated by those skilled in the art, the four cells could be distributed across a local or wide area network, and could communicate with one another by way of a network server. Moreover, it is contemplated that job data, such as job size, workflow arrival, due date, would be communicated from the cells 14 to the processing center 12. Further detailed description regarding the type of job data that can be obtained from the cells is provided in U.S. Patent Application Publication No. 20050065830 (published on Mar. 24, 2005), the pertinent portions of which are incorporated herein by reference.

A second one of the inputs for processing center 12, namely simulation program 16, may perform discrete event simulation to assess the results of improvements resulting from changes in workflow grouping, operator cross-training, grouping diverse equipment into autonomous cells and scheduling policies. Building simulation models is often a time-intensive effort especially when various scenarios have to be investigated to determine improved solutions. To facilitate the model building process, a tool, based, at least in part, on the teachings of U.S. Pat. No. 7,064,848 to Jackson et al., the pertinent portions of which are incorporated herein by reference, was developed for semi-automatically building the simulation models from a declarative user-interface.

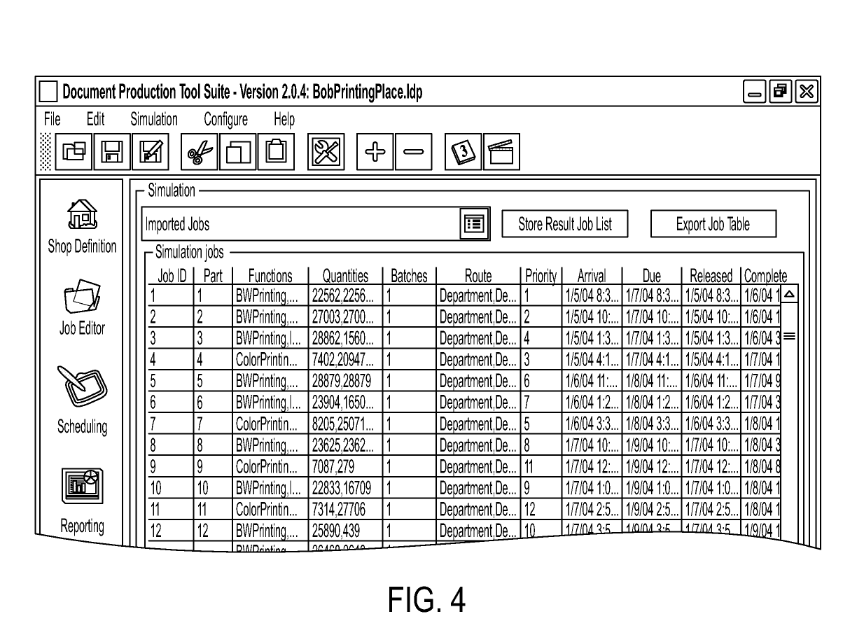

Referring to FIG. 4, a user may facilitate simulation by specifying with the user interface, among other things, equipment characteristics, shop schedule (along with other scheduling information [including schedule policies]), elements of an associated cell, and number of operators along with their skill level (in addition to any other labor characteristics). This allows for fast and efficient simulation of a large number of what-if scenarios and greatly aids in determining an improved solution out of a large search space. The scheduling policies may use min-max optimization formulation for job allocation to cells. Further details regarding simulation for document processing cells is provided in U.S. Patent Application Publication No. 20070091355 (published Apr. 26, 2007), the pertinent portions of which are incorporated herein by reference.

A third one of the inputs for the processing center 12, namely job scheduler 18, may include a job router for receiving jobs (local or remote) and determining which cells can process a given job in its entirety. The scheduler allocates the job to the feasible cells while balancing the loading of the cells. A cell scheduler sequences the jobs within the queue at the cell based on their due dates and processing time requirements using one or more heuristics. It might further split jobs into smaller efficient batches so that jobs can flow faster within the cell without excessive build-up of work-in progress (WIP). Each cell may be allocated operators who are cross-trained to perform all the operations within the cell. WIP control policies are utilized within each cell to control the release of jobs in the cell. Operators may be trained to allocate their effort within each individual cell to stations for reducing inter-process buildup of WIP. Buffers may be allocated between machines that are prone to failures using empirical heuristics derived from analytical results. Jobs that cannot be processed within a given cell may be coordinated with other cells for production. Further detailed description of software suitable for use in the job scheduler 18 is provided in U.S. Pat. No. 6,993,400 to Viassolo, the pertinent portions of which are incorporated herein by reference.

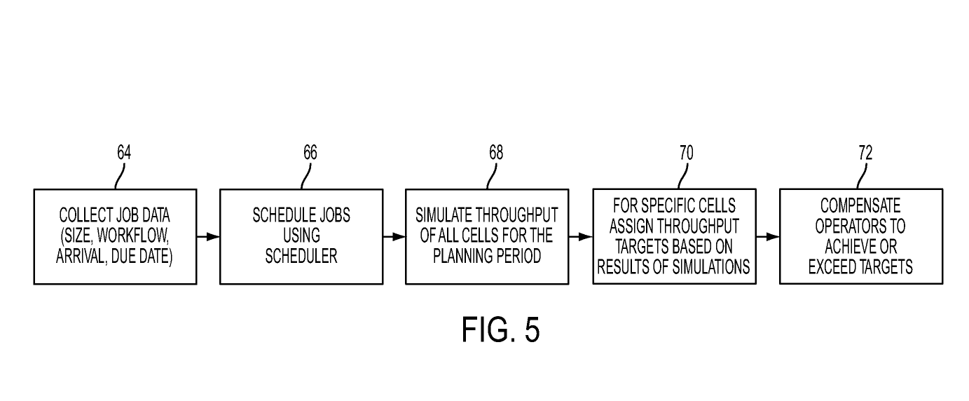

Referring now to FIGS. 2 and 5, the compensation planning processing center 12 exploits the above-described inputs to determine throughput targets for driving compensation schemes. In particular, by capturing variations in jobs, operator skills, scheduling policies and processing delays within a given document processing cell, it is possible to develop compensation schemes that are fairer and more realistic than compensation schemes currently used in many print shops. That is, a conventional compensation scheme using projected throughput to gauge compensation without taking into account possible print shop performance (resulting from the interaction between the various jobs, equipment, labor and operating policies) can be very unfair even to the most efficient machine operator.

Referring specifically to FIG. 5 (with continued reference to FIG. 2), some key functions in developing a balanced compensation scheme, in accordance with the disclosed embodiments, is shown. In particular, at 64 data for a group of jobs may be collected (for storage in memory 22), and the processor 20 (at 66) used, in conjunction with the job scheduler 18, to schedule the group of jobs. At 68, throughput may then be simulated for one or more cells in a given shop (or for a given group of cells across a network). Based the results of the simulation, throughput targets may be assigned at 70. In turn, as indicated by 72, operators may be compensated to the extent they achieve or exceed the simulation based throughput targets.

With the type of compensation scheme described above, teamwork can be readily rewarded. For example, it is disadvantageous for a printer operator to print fast enough if it leads to WIP (work-in-process) build up between printers and inserters due to inefficient inserter operator. Thus the total product throughput (inserter envelopes, for instance) of a given cell is what drives compensation policies. An example of such a policy is to provide a base-pay for cell operators who achieve a target slightly lower than what the model predicts and then provide additional pay that is a monotonically increasing function of the cell throughput. The advantage of this is that operators will try to innovate their processes beyond the assumptions baked into the modeling and simulation tool. For example, if the assumption on setups is 10 minutes in a modeling tool, the operators may innovate to lower the setup to say 8 minutes and try and increase the overall throughput of the cell. The modeling and simulation tool will also take into account job size variations (that may lead to bottleneck shifts) to determine the expected throughput of the cell. Thus one day, a cell may be producing 3000 envelopes per hour and later when the job sizes change the throughput may increase to 4000 envelopes per hour. Such changes may be accurately estimated via modeling and simulation since they are the result of a complex set of interactions among several variables.

Based on the above description, the following features of the disclosed compensation scheme should now be apparent:
In a first approach of the disclosed embodiments, compensation for an operator is based on simulated throughput representative of a predicted output of at least one of the plurality of document processing related cells within a time interval An operator target, based on the predicted output of the at least one of the plurality of document processing related cells within the time interval, may be set. In turn, compensation of the operator may be based on the extent to which an actual output of the at least one of the plurality of document processing related cells within the time interval exceeds the operator target.
In one example of the first approach, the operator target may be set to be approximately equal to or greater than the predicted output of the at least one of the plurality of document processing related cells within the time interval. And, in another example, the operator target may be set to be a selected amount less than the predicted output of the at least one of the plurality of document processing related cells within the time interval.
in general, the compensation scheme is dynamic and, for the first approach, a new simulation can be performed each time it Is perceived that a job mix introduced to the at least one of the plurality of document processing related cells has changed. That is, each time the job mix changes, a set of job processing related information may be read and the new simulation is performed. Based on the new simulation, an updated compensation plan may be developed.
In a second approach of the disclosed embodiments, compensation for first and second operators may be based on the first and second simulated throughput values. In practice, a first target based on the first simulated throughput value for a first document processing device may be set and a second target based on the second simulated throughput value for a second document processing device may set. Additionally, one of the first and second target values may vary as a function of the other of the first and second target values.
In one instance of the second approach, both the first target and the second target may be set so as to optimize operation at the first document processing device when the second document processing device is unable process the output of the first document processing device within a selected time interval. In this one instance of the second approach, the first document processing device may be configured as a printer and the second document processing device may be configured as a finishing device. Additionally, a compensation level for the first operator would not necessarily be incrementally increased when the output of the first document processing related device exceeds the first target by a selected amount. In yet another instance of the second approach, the first target and second target may be set in such a way as to account for an inability of the first document processing related device to provide a selected amount of input to the second document processing related device within a selected time interval.

The claims, as originally presented and as possibly amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A system for planning compensation for a document processing: arrangement including a plurality of document processing related cells, each document processing related cell including a plurality of document processing related devices functioning cooperatively to create a cell throughput, comprising:
A. a processor;
B. a memory for storing (a) a functional description of each document processing related device in at least one of the plurality of document processing related cells in memory, and (b) a set of job processing related information in memory, the set of job processing related information corresponding with a number of jobs to be processed with the at least one of the plurality of document processing related cells, said memory comprising one or more programming instructions that, when executed, instruct the processor to:
(1) read both the stored functional description of each device in the at least one of the plurality of document processing related cells and the set of job processing related information,
(2) responsive to said B(1), perform a simulation with the simulation being used to generate a simulated throughput value representative of a predicted output of the at least one of the plurality of document processing related cells within a time interval, and
(3) vary compensation for an operator responsible for operating the at least one of the plurality of document processing related cells based on the simulated throughput representative of the predicted output of the at least one of the plurality of document processing related cells within the time interval.

2. The system of claim 1, wherein said B(3) includes setting an operator target based on the predicted output of the at least one of the plurality of document processing related cells within the time interval.

3. The system of claim 2, wherein compensation of the operator is based on the extent to which an actual output of the at least one of the plurality of document processing related cells within the time interval exceeds the operator target.

4. The method of claim 2, wherein the operator target is set to be approximately equal to or greater than the predicted output of the at least one of the plurality of document processing related cells within the time interval.

5. The method of claim 2, wherein the operator target is set to be a selected amount less than the predicted output of the at least one of the plurality of document processing related cells within the time interval.

6. The method of claim 1, in which (1) the set of job processing related information comprises a first set of job processing related information corresponding with a first number of jobs to be processed with the at least one of the plurality of document processing related cells within a first time interval, (2) the simulated throughput value comprises a first simulated throughput value representative of a first predicted output of the at least one of the plurality of document processing related cells within the first time interval, (3) the simulation comprises a first simulation, and (4) the compensation plan comprises a first compensation plan, further comprising:
F. storing a second set of job processing related information in memory, the second set of job processing related information corresponding with a second number of jobs to be processed with the at least one of the plurality of document processing related cells;
G. reading the second set of job processing related information with the processor;
H. responsive to said reading of G, using the processor to perform a second simulation with the second simulation being used to generate a second simulated throughput value representative of a second predicted output of the at least one of the plurality of document processing related cells within a second time interval; and
I. developing a second compensation plan based on the second simulated throughput value representative of the second predicted output from the at least one of the plurality of document processing related cells within the second time interval.

7. A system for planning compensation for a document processing arrangement including a plurality of document processing related cells, each document processing related cell including a plurality of document processing related devices functioning cooperatively to generate a cell output, comprising:
A. a processor;
B. a memory for storing (a) a functional description of each document processing device in at least one of the document processing related cells, the at least one of the plurality of document processing related cells including a first document processing related device operated by a first operator and a second document processing related device operated by a second operator, and (b) a set of job processing related information, the set of job processing related information corresponding with a number of jobs to be processed with the at least one of the plurality of document processing related cells, said memory comprising one or more programming instructions that, when executed, instruct the processor to:
(1) read both the stored functional description of each document processing related device in the at least one of the document processing related cells and the set of job processing related information,
(2) responsive to said B(2), use the processor to perform a simulation with the simulation being used to generate a first simulated throughput value representative of a predicted output of the first document processing related device within a first time interval and a second simulated throughput value representative of a predicted output for the second document processing related device within a second time interval; and
(3) compensate the first and second operators based on the first and second simulated throughput values.

8. The system of claim 7, wherein a first target based on the first simulated throughput value is set and a second target based on the second simulated throughput value is set, and wherein one of the first and second target values varies as a function of the other of the first and second target values.

9. The system of claim 8, wherein both the first target and the second target are set so as to optimize operation at the first document processing device when the second document processing device is unable process the output of the first document processing device within a selected time interval.

10. The system of claim 9, wherein the first document processing device is configured as a printer and the second document processing device is configured as a finishing device.

11. The system of claim 8, wherein a compensation level for the first operator is not incrementally increased when the output of the first document processing related device exceeds the first target by a selected amount.

12. The system of claim 8, wherein the first target and second target are set in such a way as to account for an inability of the first document processing related device to provide a selected amount of input to the second document processing related device within a selected time interval.

13. A method for planning compensation for a document processing arrangement including a plurality of document processing related cells, each document processing related cell including a plurality of document processing related devices functioning cooperatively to create a cell throughput, comprising:
A. storing a functional description of each document processing related device in at least one of the plurality of document processing related cells in memory;
B. storing a set of job processing related information in memory, the set of job processing related information corresponding with a number of jobs to be processed with the at least one of the plurality of document processing related cells;
C. reading, with a processor, both the stored functional description of each device in the at least one of the plurality of document processing related cells and the set of job processing related information;
D. responsive to said C., using the processor to perform a simulation with the simulation being used to generate a simulated throughput value representative of a predicted output from the at least one of the plurality of document processing related cells within a time interval; and
E. varying compensation for an operator of the at least one of the plurality of document processing related cells based on the simulated throughput representative of the predicted output from the at least one of the plurality of document processing related cells within the time interval.

14. The method of claim 13, wherein said F includes setting an operator target based on the predicted output of the at least one of the plurality of document processing related cells within the time interval.

15. The method of claim 14, further comprising compensating the operator based on the extent to which an actual output of the at least one of the plurality of document processing related cells within the time interval exceeds the operator target.

16. The method of claim 14, wherein the operator target is set to be approximately equal to or greater than the predicted output of the at least one of the plurality of document processing related cells within the time interval.

17. The method of claim 14, wherein the operator target is set to be a selected amount less than the predicted output of the at least one of the plurality of document processing related cells within the time interval.

18. The method of claim 13, in which (1) the set of job processing related information comprises a first set of job processing related information corresponding with a first number of jobs to be processed with the at least one of the plurality of document processing related cells within a first time interval, (2) the simulated throughput value comprises a first simulated throughput value representative of a first predicted output of the at least one of the plurality of document processing related cells within the first time interval, (3) the simulation comprises a first simulation, and (4) the compensation plan comprises a first compensation plan, further comprising:
F. storing a second set of job processing related information in memory, the second set of job processing related information corresponding with a second number of jobs to be processed with the at least one of the plurality of document processing related cells;
G. reading the second set of job processing related information with the processor;
H. responsive to said G, using the processor to perform a second simulation with the second simulation being used to generate a second simulated throughput value representative of a second predicted output from the at least one of the plurality of document processing related cells within a second time interval; and
I. developing a second compensation plan based on the second simulated throughput value representative of the second predicted output from the at least one of the plurality of document processing related cells within the second time interval.

19. A method for planning compensation for a document processing arrangement including a plurality of document processing related cells, each document processing related cell including a plurality of document processing related devices functioning cooperatively to generate a cell output, comprising:
A. storing, in memory, a functional description of each document processing device in at least one of the document processing related cells, the at least one of the plurality of document processing related cells including a first document processing related device operated by a first operator and a second document processing related device operated by a second operator;
B. storing a set of job processing related information in memory, the set of job processing related information corresponding with a number of jobs to be processed with the at least one of the plurality of document processing related cells;
C. reading, with a processor, both the stored functional description of each document processing related device in the at least one of the document processing related cells and the set of job processing related information;
D. responsive to said C., using the processor to perform a simulation with the simulation being used to generate a first simulated throughput value representative of a predicted output of the first document processing related device within a first time interval and a second simulated throughput value representative of a predicted output for the second document processing related device within a second time interval; and
E. compensating the first and second operators based on the first and second simulated throughput values.

20. The method of claim 19, further comprising:
F. setting a first target based on the first simulated throughput value and a second target based on the second simulated throughput value, wherein said setting is performed in such a way that one of the first and second target varies as a function of the other of the first and second target values.

21. The method of claim 20, wherein said setting is performed in such a way as to optimize operation at the first document processing device when the second document processing device in unable process the output of the first document processing device within a selected time interval.

22. The method of claim 21, wherein the first document processing device is configured as a printer and the second document processing device is configured as a finishing device.

23. The method of claim 21, wherein a compensation level for the first operator is not incrementally increased when the output of the first document processing related device exceeds the first target by a selected amount.

24. The method of claim 20, wherein said setting is performed in such a way as to account for an inability of the first document processing related device to provide a selected amount of input to the second document processing related device within a selected time interval.
